(19) United States
(12) Patent Application Publication
(10) Pub. No.: US 2008/0095412 A1
(43) Pub. Date: Apr. 24, 2008

(54) Method And System For Extracting Liveliness Information From Fingertip

(75) Inventors: Ichiro Fujieda, Shiga (JP); Katsuki Tai, Kyoto (JP)

Correspondence Address: OLIFF & BERRIDGE, PLC, P.O. BOX 320850, ALEXANDRIA, VA, 22320-4850, US

(73) Assignees: THE RITSUMEIKAN TRUST, Kyoto-shi, Kyoto (JP); A'SYCK CO., LTD., Uji-shi, Kyoto (JP)

(21) Appl. No.: 11/661,865

(22) PCT Filed: Sep. 13, 2005
(86) PCT No.: PCT/JP05/16836

§ 371 Date: Mar. 5, 2007

(30) Foreign Application Priority Data
Sep. 13, 2004 (JP) 2004-265027

(51) Int. Cl. G06K 9/00

(52) U.S. Cl. 382/124

(57) ABSTRACT

The present invention intends to provide a method for liveliness detection and fitness measurement using information optically extracted from a fingertip. For liveliness detection, the present method examines the change in a color index of a finger at its touching portion measured while the finger is being pressed onto an inspection surface and while the finger is released from the same surface. If the change is equal to or larger than a predetermined value, the finger is regarded as a live finger. For fitness measurement, an index indicative of the stiffness of the blood vessel of the finger is obtained from the change in the color index of the finger at its touching portion against the change in the contact area of the finger while the finger is being pressed onto the inspection surface.

### TECHNICAL FIELD

The present invention relates to a method and system for extracting liveliness information from a fingertip. The “liveliness information” hereby includes information for determining whether or not the finger concerned actually belongs to a human being, i.e. whether the finger is a real finger of a human being (i.e. a live finger) or a faked one (i.e. a non-living, faked finger), and also includes information about fitness indicated by the stiffness of the blood vessel inside the finger of the human being.

### BACKGROUND ART

Nowadays, many personal computers and mobile phones practically used have fingerprint authentication systems intended to replace conventional, password-based systems. Widespread usage of the fingerprint authentication system in the world will contribute to the expansion of electronic commerce, the electronic government and other electronic services, the deterrence of cyber-based crimes using the Internet or other networks, and the prevention of terrorist attacks on airports, nuclear reactors or other facilities.

However, it has been reported that these products are often fragile against faked fingers or similar faked articles (which are generally called the “faked finger” hereinafter). This means that the system cannot detect the faked finger in some cases. As a possible counter measure against faked fingers, the inventors of the present patent application have proposed a liveliness detection method based on the changes in the area and color of a fingerprint image during a continuous input action (see Patent Document 1). This liveliness detection method includes the steps of calculating the correlation coefficient between the color of the finger at its touching portion and either the contact area or contact pressure of the finger on an inspection surface and determining whether the finger is a live finger or a faked one from the correlation coefficient. The color of the finger is expressed by an sRGB value given by a color image sensor for capturing a fingerprint image.

There are several reports disclosing techniques for optically extracting liveliness information from a fingertip. Examples include an optical oximetry for measuring the oxygen saturation of hemoglobin in the peripheral blood vessel of a fingertip (Non-Patent Document 1), a technique of imaging a hemoglobin distribution (Non-Patent Document 2), a technique of checking fitness by detecting the pulse wave from a fingertip (Patent Document 2), an attempt of measuring a blood-sugar level (Non-Patent Document 3), and a portable blood-flow sensor (Non-Patent Document 4).

[Patent Document 1] Japanese Unexamined Patent Application Publication No. 2003-075135

[Patent Document 2] Japanese Unexamined Patent Application Publication No. 2003-144420

[Non-Patent Document 1] Setsuo Takatani, “Hikari-Okishimetorii No Rironteki Haikei To Genjou, Shourai (Optical Oximetry: Background Theory, Present Situation and Future Development),” Kogaku (Optics), Vol. 30, No. 10, pp. 644-650 (2001)

[Non-Patent Document 2] Ikuo Konishi, Yasunobu Ito, Naofumi Sakauchi, Manami Kobayashi and Yoshio Tsunazawa, “A new optical imager for hemoglobin distribution in human skin,” Optical Review, Vol. 10, No. 6, pp. 592-595 (2003)

[Non-Patent Document 3] Mamoru Tamura, “Mushinshuu Kettouchi Sokuteihou No Genjou To Kadai (Non-invasive Method for Measuring Blood-Sugar Level: Present Situation and Problems),” Kogaku (Optics), Vol. 33, No. 7, pp. 380-386 (2004)

[Non-Patent Document 4] Eiji Higurashi and Renshi Sawada, “Keitai Kanouna Yubikitasu Ketsuryuu Sensa (Portable Ubiquitous Blood-Flow Sensor),” Dai Ni-kai Shuuseki Hikari Debaisu Gijutsu Kenkyuukai Puroguramu (Program of the Second Integrated Optical Devices Technology Workshop), IPD02-12, pp. 33-36 (2003)

### DISCLOSURE OF THE INVENTION

### Problem to be Solved by the Invention

Concerning the liveliness detection, the method disclosed in Patent Document 1 only checks the relationship between the contact area and the color of the finger on the inspection surface. This relationship between the two parameters is unique if a faked finger made of rubber or similar material is used, whereas, if the finger is a live finger, the relationship between the two parameters during the finger-pressing phase usually differs from that during the finger-releasing phase. Focusing on this difference will further improve the accuracy of the liveliness detection.

Concerning the fitness measurement, each of the aforementioned various methods can extract one or more indices reflecting certain aspects of human fitness. It is of course possible to create more indices that are not covered by the aforementioned methods. If a fingerprint sensor has a function of evaluating human fitness, it will be possible for users to check their fitness everyday when, for example, they log in a computer network system. In that case, increasing the number of items of fitness information that can be checked by the fingerprint sensor will make the sensor more useful as a fitness evaluation system.

The present invention solves these two problems concerning fingerprint sensors by one and the same technique.

### Means for Solving the Problems

To solve the aforementioned problems, the present invention provides a method for extracting liveliness information from a fingertip, which is characterized in that the liveliness information is extracted from the relationship between the following two properties of a finger being pressed onto an inspection surface: the color of the finger at its touching portion, and either the contact area of the finger or a quantity reflecting the contact area.

The description “the finger is being pressed onto the inspection surface” merely concerns the relative relationship between the finger and the inspection surface; it allows the case where the finger moves while the inspection surface is statically held, the case where the inspection surface moves the finger while the finger is statically held, and the case where the two elements independently move.

To solve the aforementioned problem concerning the liveliness detection, the present invention provides a liveliness detection method using information extracted from a fingertip, which is characterized in that it determines whether or not the finger is a live finger, on the basis of the change in a color index of the finger at its touching portion during one or both of the following two phases: a pressing phase, in which the finger is being pressed onto an inspection surface, and a releasing phase, in which the finger is being released from the inspection surface.

As the aforementioned color index, any of the chromaticity coordinate x, chromaticity coordinate y and tristimulus value Y of the CIE color specification system can be used. The chromaticity coordinate x and the tristimulus value Y are particularly preferable.

If an LHS system is used as the color specification system, the color index may be any of the luminance L, hue H and chroma saturation S, where the chroma saturation S is particularly preferable.

The light source used in the present invention may preferably include a combination of a green light source and a red light source. In this case, it is preferable to use the ΔR′i, ΔR′p and Δyi values, which are to be explained later, as the aforementioned index.

The center of the range within which the color of the finger is to be detected during the pressing or releasing phase may be automatically determined by image processing.

To carry out the methods described thus far, the present invention provides a liveliness detection system using information extracted from a fingertip, which includes:

a) an inspection surface onto which a finger is to be pressed;

b) a color detector for measuring the color of the finger at the portion touching the inspection surface;

c) a color monitor for checking a color index of the finger at its touching portion during one or both of the following phases: a pressing phase, in which the finger is being pressed onto the inspection surface, and a releasing phase, in which the finger is being released from the inspection surface; and

d) a liveliness detector for determining whether or not the finger is a live finger, on the basis of the change in the color during each of the aforementioned one or both phases.

To solve the problem concerning the fitness measurement, the present invention provides a fitness measurement method using information extracted from a fingertip, which is characterized in that an index indicative of the stiffness of the blood vessel of a finger being pressed onto an inspection surface is derived from the change in a color index of the finger at its touching portion, where the color index corresponds to the change in the contact area of the finger or a quantity reflecting the contact area.

As the aforementioned color index, any of the chromaticity coordinate x, chromaticity coordinate y and tristimulus value Y of the CIE color specification system can be used. The chromaticity coordinate x and the tristimulus value Y are particularly preferable. If an LHS system is used, the color index may be any of the luminance L, hue H and chroma saturation S, where the chroma saturation S is particularly preferable.

To carry out the previously described method, the present invention provides a fitness measurement system using information extracted from a fingertip, which includes:

a) an inspection surface onto which a finger is to be pressed;

b) an area-measuring means for measuring either the contact area of the finger on the inspection surface or a quantity reflecting the contact area;

c) a color detector for measuring the color of the finger at the portion touching the inspection surface; and

d) a stiffness calculator for computing an index indicative of the stiffness of the blood vessel of the finger from the change in an index of the aforementioned color corresponding to the change of the contact area.

### EFFECT OF THE INVENTION

The method and system according to the present invention can clearly discriminate live fingers from faked ones.

The method and system for fitness measurement enable a fingerprint sensor to be used for evaluating human fitness. For example, in a computer network system, users can check their fitness from the measurement values by the fingerprint sensor when they log in the network. In that case, increasing the number of items of fitness information that can be checked by the fingerprint sensor will make that sensor more useful as a fitness evaluation system.

### BRIEF DESCRIPTION OF THE DRAWINGS

FIG. 1 is a schematic arrangement view of the components of the fingerprint sensor used in the examples of the present invention.

FIG. 2 is a graph showing the temporal change of the chromaticity coordinate x, chromaticity coordinate y and the tristimulus value Y measured while a finger was being pressed onto an inspection surface at a low speed and then released.

FIG. 3 is a graph showing the temporal change of the chromaticity coordinate x, chromaticity coordinate y and the tristimulus value Y measured while a finger was being pressed onto an inspection surface at a medium speed and then released.

FIG. 4 is a graph showing the temporal change of the chromaticity coordinate x, chromaticity coordinate y and the tristimulus value Y measured while a finger was being pressed onto an inspection surface at a high speed and then released.

FIG. 5 is a graph showing the relationship between the contact area of a finger on the inspection surface and the chromaticity coordinate x, chromaticity coordinate y and the tristimulus value Y measured while a finger was being pressed onto an inspection surface at a low speed and then released.

FIG. 6 is a graph showing the relationship between the contact area of the finger on the inspection surface and the chromaticity coordinate x, chromaticity coordinate y and the tristimulus value Y measured while a finger was being pressed onto an inspection surface at a medium speed and then released.

FIG. 7 is a graph showing the relationship between the contact area of the finger on the inspection surface and the chromaticity coordinate x, chromaticity coordinate y and the tristimulus value Y measured while a finger was being pressed onto an inspection surface at a high speed and then released.

FIG. 8 is a graph showing the relationship between the contact area of the finger on the inspection surface and the chromaticity coordinate x, chromaticity coordinate y and the tristimulus value Y measured while a finger of the second subject was being pressed onto an inspection surface at a medium speed and then released.

FIG. 9 is a graph showing the relationship between the contact area of the finger on the inspection surface and the chromaticity coordinate x, chromaticity coordinate y and the tristimulus value Y measured while a finger of the third subject was being pressed onto an inspection surface at a medium speed and then released.

FIG. 10 is a graph showing the relationship between the contact area of the finger on the inspection surface and the chromaticity coordinate x, chromaticity coordinate y and the tristimulus value Y measured while a finger of the fourth subject was being pressed onto an inspection surface at a medium speed and then released.

FIG. 11 is a graph showing the relationship between the contact area of the finger on the inspection surface and the chromaticity coordinate x, chromaticity coordinate y and the tristimulus value Y measured while a finger of the fifth subject was being pressed onto an inspection surface at a medium speed and then released.

FIG. 12(a) schematically shows the change of the chromaticity coordinate x measured while a finger was being pressed onto the inspection surface and then released, and FIG. 12(b) schematically shows the change of the tristimulus value Y during the same period of time.

FIG. 13 is a graph showing the temporal change of the chromaticity coordinate x, chromaticity coordinate y and the tristimulus value Y measured while a faked finger was being pressed onto an inspection surface and then released.

FIG. 14 is a graph showing the relationship between the contact area of the faked finger on the inspection surface and the chromaticity coordinate x, chromaticity coordinate y and the tristimulus value Y measured while the faked finger was being pressed onto an inspection surface and then released.

FIG. 15 is a graph showing the relationship between the contact area of the finger on the inspection surface and the values of [Area]/[Chromaticity coordinate x], [Area]/[Chromaticity coordinate y] and [Area]/[Tristimulus value Y] measured while a finger of the sixth subject was being pressed onto an inspection surface at a medium speed and then released.

FIG. 16 is a graph showing the relationship between the contact area of the finger on the inspection surface and the values of [Area]/[Chromaticity coordinate x], [Area]/[Chromaticity coordinate y] and [Area]/[Tristimulus value Y] measured while a finger of the seventh subject was being pressed onto an inspection surface at a medium speed and then released.

FIG. 17 is a graph showing the relationship between the contact area of the finger on the inspection surface and the values of [Area]/[Chromaticity coordinate x], [Area]/[Chromaticity coordinate y] and [Area]/[Tristimulus value Y] measured while a finger of the eighth subject was being pressed onto an inspection surface at a medium speed and then released.

FIG. 18 is a graph showing the relationship between the contact area of the finger on the inspection surface and the values of [Area]/[Chromaticity coordinate x], [Area]/[Chromaticity coordinate y] and [Area]/[Tristimulus value Y] measured while a finger of the ninth subject was being pressed onto an inspection surface at a medium speed and then released.

FIG. 19 is a graph showing the relationship between the contact area of the finger on the inspection surface and the values of [Area]/[Chromaticity coordinate x], [Area]/[Chromaticity coordinate y] and [Area]/[Tristimulus value Y] measured while a finger of the tenth subject was being pressed onto an inspection surface at a medium speed and then released.

FIGS. 20(a) and 20(b) are arrangement views of another type of fingerprint sensor that can be used for carrying out the present invention.

FIG. 21(a) is a graph showing the relationship between the pressure of a live finger and the spectrum during the pressing phase, and FIG. 21(b) is the emission spectrum of the GR light source used in the second example.

FIGS. 22(a) and 22(b) are graphs showing the change of the color signal monitored during the pressing and releasing phases of a live finger (FIG. 22(a)) and a faked finger (FIG. 22(b)), both being used in the second example.

FIGS. 23(a) to 23(d) are graphs for explaining the various indices used in the second example.

FIG. 24(a) is a distribution chart of the values of the index ΔR′i of the live finger group and the faked finger group, and FIG. 24(b) a distribution chart of the values of the index Δyi of the same groups.

FIG. 25 is a table showing the differences of various indices between the live finger group and the faked finger group.

FIGS. 26(a) to 26(c) are graphs showing the results of a measurement performed on a live finger as an example of the measurement using an LHS color specification system.

FIG. 27 is a table showing the results of the measurement using the LHS color specification system.

FIGS. 28(a) and 28(b) are diagrams for explaining an automatic center determination method.

FIGS. 29(a) and 29(b) are graphs showing the difference between the index obtained by the fixed center method and that obtained by the automatic center determination method.

FIG. 30 is a table showing the difference between the index obtained by the fixed center method and that obtained by the automatic center determination method.

### EXPLANATION OF NUMERALS

10 . . . Light Source (LED)
11 . . . Light-Guiding Plate
12 . . . Fingertip
13 . . . Image Sensor
14 . . . Image Processor

### BEST MODE FOR CARRYING OUT THE INVENTION

In the method for extracting liveliness information from a fingertip according to the present invention, when a finger is being pressed onto an inspection surface, the liveliness information is extracted from the relationship between the color of the finger at its touching portion and either the contact area of the finger or a quantity reflecting the contact area (for example, the pressure from the finger measured with a pressure sensor can be regarded as a quantity reflecting the contact area). Since there is no need to detect any other physical quantities than the finger color and the contact area of the finger or the quantity reflecting the contact area, it is possible to use a very simple system to extract liveliness information. For example, the method for extracting liveliness information according to the present invention can be carried out with a system using a conventional fingerprint sensor, because the image information produced by conventional fingerprint sensors contains both the area information and the color information. The software program for processing the collected data can be also very simple.

The liveliness detection method using information extracted from a fingertip according to the present invention also requires two kinds of information: phase information and color information. The phase information indicates whether the finger is being pressed onto the inspection surface (the pressing phase) or being released from the inspection surface (the releasing phase), and the color information indicates how the finger color changes during each phase. The phase information can be derived from the temporal change of the contact area of the finger or any other quantity that reflects the contact area. These two kinds of information can be obtained with a system including a conventional fingerprint sensor, as in the previous example. The pressing and releasing phases can be also distinguished from each other by monitoring the change in the information indicating the contact pressure of the finger onto the inspection surface. It is also possible to intentionally specify the period of time for users to press their finger onto the inspection surface. In this case, the two phases can be distinguished from each other by simply checking the elapsed time. In the latter case, for convenience of the users' finger-pressing action, it is possible to use small lamps (prompt lamps) that turn on, one by one, at certain intervals of time.

In the present liveliness detection method, the color of the finger at its touching portion is measured while the finger is being pressed onto the inspection surface (or the inspection surface is being pressed onto the finger) and while the finger is being released from the inspection surface. Then, from the change of the color, it is determined whether the finger is a live finger or a faked one. As will be explained later, the experiments conducted by the present inventors have demonstrated that the finger color during the first phase differs from that of the second phase if the finger is a live finger. The experiments have also proved that the color difference will be the most remarkable in the case where the sRGB value primarily measured by a normal image sensor is converted to the chromaticity coordinates x and y and the tristimulus value Y and then the coordinates x is used as the color index. The tristimulus value Y, which exhibits the second largest difference, can be also used as the color index.

The difference in the finger color between the pressing phase and the releasing phase probably results from the following fact: During the pressing phase, the pressure rapidly pushes the blood away from the blood vessel of the finger, causing the finger color to change. Once displaced, the blood cannot quickly return to the pressed portion of the finger even after the pressure is removed; it takes some time for the blood to be back to the original state, due to the resistance of the blood vessel, as will be described later. Naturally, a faked finger, which does not have such a complex structure, shows the same color change in both the pressing and releasing phases. Therefore, according to the present method, a live finger can be clearly distinguished from a faked finger.

Another reason for the effectiveness of the present invention in discriminating live fingers from faked ones is because the present method detects some response of an organism to an external stimulus. As a comparative example, suppose a method in which pulse waves due to the pulsating flow of blood are detected by examining the change in the color of the finger at its touching portion while the finger is pressed onto the inspection surface. This method could be used as a liveliness detection method. However, it is not an “liveliness” detection method in a genuine sense because it is not the kind of method that examines some response to an external stimulus. In contrast, the method according to the present invention examines a response to an external stimulus and is more reliable in discriminating organisms from non-organisms.

The “change” of the finger color may be hereby defined as a simple difference between the x-coordinates at the two points in time or as a ratio between the two coordinate values. Any index can be used as long as it reflects some change of the color between the two phases.

It is possible to examine the change in the color of the finger at its touching portion only during the phase in which the finger is being pressed onto the inspection surface or only during the phase in which the finger is being released from the inspection surface. Such a change can be detected by performing an integral calculation on the area-color curve.

In the fitness measurement method using information extracted from a fingertip according to the present invention, when a finger is being pressed onto an inspection surface, the change in the color of the finger at its touching portion against the change in the contact area of the finger or a quantity reflecting the contact area (as stated earlier, the pressure from the finger measured with a pressure sensor can be regarded as a quantity reflecting the contact area) is measured. A test conducted by the present inventors on multiple subjects showed that there was a negative correlation between the ratio (or percentage) of the change of the finger color to the change of the contact area and the age of the subjects. This means that the change of the finger color against the change of the contact area is smaller for older subjects.

This result can be explained as follows: When a finger is pressed onto the inspection surface, the pressure displaces the blood from the blood vessel of the finger to outer blood vessels. This pressure, p, and the blood flow, i, has a relationship similar to that between the voltage V and the current I in an electrical circuit. From this analogy, it is possible to define a resistance against the blood flow in the finger as r=p/i, which corresponds to the resistance R=V/I of the electrical circuit. This resistance r against the blood flow i can be regarded as the resistance of the blood vessel and should reflect the stiffness of the blood vessel. Thus, the value obtained by the method according to the present invention can be regarded as a new fitness index indicative of the stiffness of the blood vessel of the finger.

Similar to the previous cases, the fitness measurement method using information extracted from a fingertip according to the present invention also requires two kinds of information: the contact area of the finger on the inspection surface or a quantity reflecting the contact area, and the finger color. Therefore, this method can be carried out using a conventional fingerprint sensor. However, in contrast to the previous methods, the present method has no essential tie with fingerprint sensors. Accordingly, it is possible to use a dedicated device having similar functions (e.g. a fitness-measuring apparatus).

In the fitness measurement method using information extracted from a fingertip according to the present invention, the change of the finger color appears in both hue and luminance and is particularly remarkable in the luminance. Therefore, if an sRGB value obtained with a normal image sensor is converted to the chromaticity coordinates x, y and the tristimulus value Y, it is preferable to use the tristimulus value Y. This particular importance of the tristimulus value Y also suggests that it is allowable to use the sRGB value as they are, without converting them to the chromaticity coordinates x, y and the tristimulus value Y. Moreover, instead of the image sensor, it is possible to use a simple photo sensor that measures only the brightness.

In addition to the chromaticity coordinates x, y and the tristimulus value Y mentioned above, Lab, Luv or any other index that can be uniquely converted from the XYZ tristimulus value can be used as the index of the finger color. Even if any of these indices is used, the methods and systems according to the present invention described thus far can be similarly carried out by measuring the color change as described earlier.

### EXAMPLES

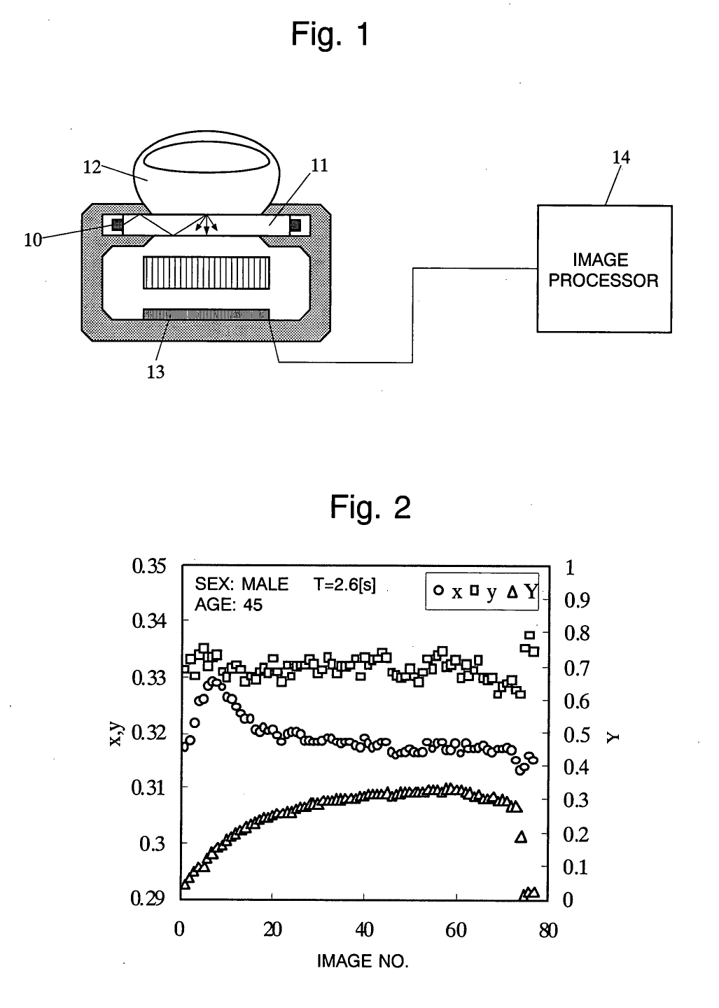

In the following example of the liveliness detection method according to the present invention, a live finger is discriminated from a faked finger with a fingerprint sensor. The fingerprint sensor used in this example is constructed to detect the light diffused within the finger or passing through the finger. For example, as shown in FIG. 1, it includes a light source 10 for sending light through the light-guiding plate 11 onto the fingertip 12, and an image sensor 13, such as a charge-coupled device (CCD), for detecting scattered light coming from the fingertip 12 through an appropriate optical system. Examples of the optical system include: a system using a gradient index lens for forming an image at the same magnification, an image-forming system using normal lenses, and an image-forming system using mirrors for bending the optical path to create a thin structure. The image sensor 13 continuously detects color images of the touching portion of the fingertip and produces signals indicative of sRGB values. When the present system is used as a normal fingerprint sensor, the signals produced by the image sensor 13 are sent to the image processor 14, which reproduces an image from the signals received. Then, the image processor 14 compares the reproduced image with a specific image (e.g. the fingerprint image of each registered user) and evaluates the degree of matching between them by a predetermined evaluation method. If the degree of matching is higher than a predetermined value, the fingerprint image concerned is judged as belonging to a registered user and a judgment signal is sent to the system using the fingerprint sensor. There are various types of fingerprint sensors currently available. For example, FIG. 20 shows a fingerprint sensor that laterally casts light onto the finger. This and other types of fingerprint sensors can be also used to implement the present invention.

In the present example, the signal from the image sensor 13 was used for liveliness detection as follows: First, one subject was requested to press his fingertip onto the inspection surface (i.e. the light-guiding plate 11) of the fingerprint sensor at three different speeds: low, medium and high. After the fingertip was fully pressed onto the inspection surface, the finger was quickly removed. The three speeds were defined by the period of time T between the point in time at which the fingertip started touching the image sensor 13 and the point in time at which it was removed: T=2.6 seconds at the low speed, T=1.8 seconds at the medium speed and T=1.0 seconds at the high speed.

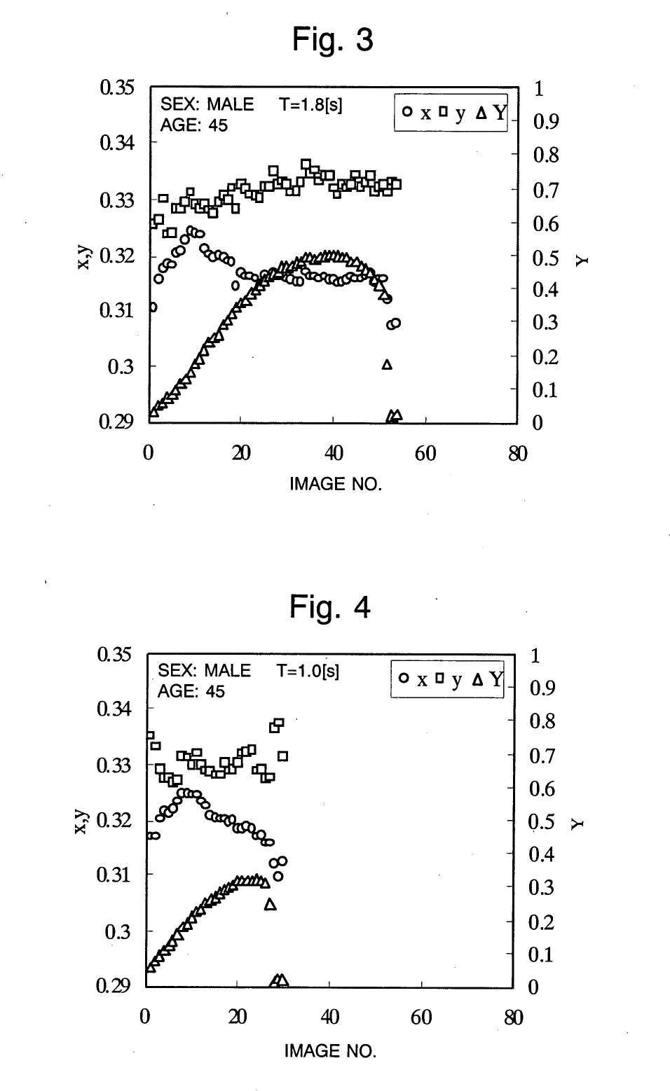

Meanwhile, a series of image data were received from the image sensor 13 at a rate of 30 frames per second, and the sRGB value of the central portion of each image was converted to the chromaticity coordinates x, y and the tristimulus value Y. Then, these values were plotted against the image serial numbers. FIGS. 2 to 4 each show the values of the chromaticity coordinate x, the chromaticity coordinate y and the tristimulus value Y plotted on a graph, respectively. FIG. 2 shows the result obtained at T=2.6 seconds, FIG. 3 at T=1.8 seconds and FIG. 4 at T=1.0 seconds. The subject was a 45-year-old male. In FIGS. 2 to 4, the image serial numbers on the abscissa can be regarded as equivalent to the points in time. Therefore, these figures can be regarded as showing the temporal change of the chromaticity coordinate x, chromaticity coordinate y and tristimulus value Y during the pressing and releasing phases.

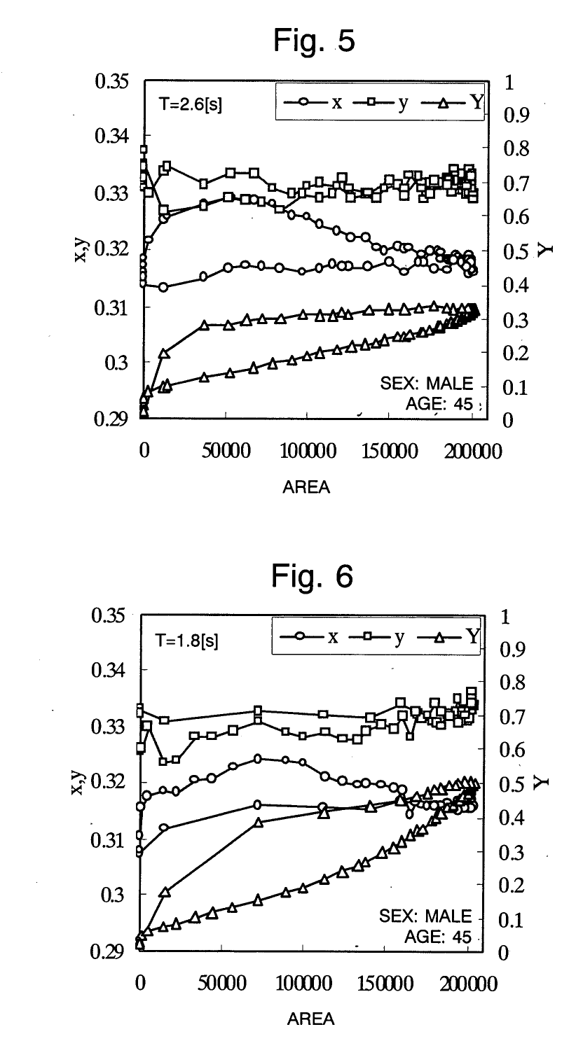

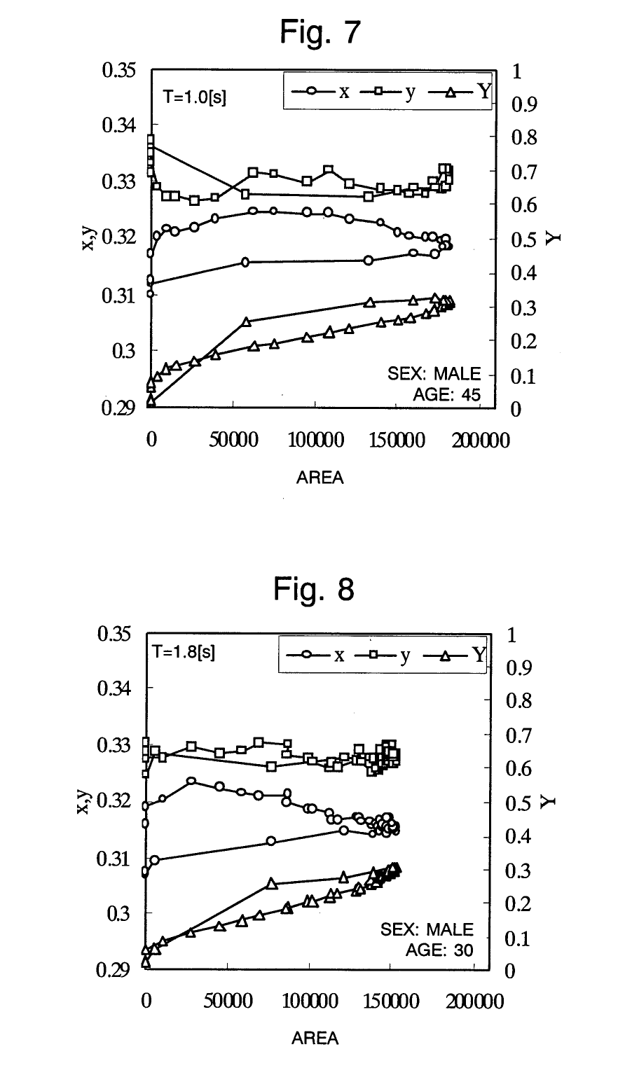

Next, the contact area S of the finger on the inspection surface (in units of pixels) was calculated from each image, and the chromaticity coordinate x, chromaticity coordinate y and tristimulus value Y were plotted against the area S. FIGS. 5 to 7 shows the results. These figures confirm the following points: The chromaticity coordinate x initially increases with the increase in the area S and later decreases. While the finger is being released from the inspection surface (that is, the pressure is being removed), the change of the chromaticity coordinate x is small. Thus, on the graph with the chromaticity coordinate x plotted against the area, the trajectory of the points during the pressing phase differs from that of the releasing phase. In contrast, the chromaticity coordinate y does not show any remarkable characteristic. The tristimulus value Y increases and decreases with the area, forming a hysteresis loop whose trajectory during the pressing phase differs from that of the releasing phase, as in the case of the chromaticity coordinate x. The characteristics hereby described are commonly recognized irrespective of the pressure time T=2.6, 1.8 and 1.0 seconds.

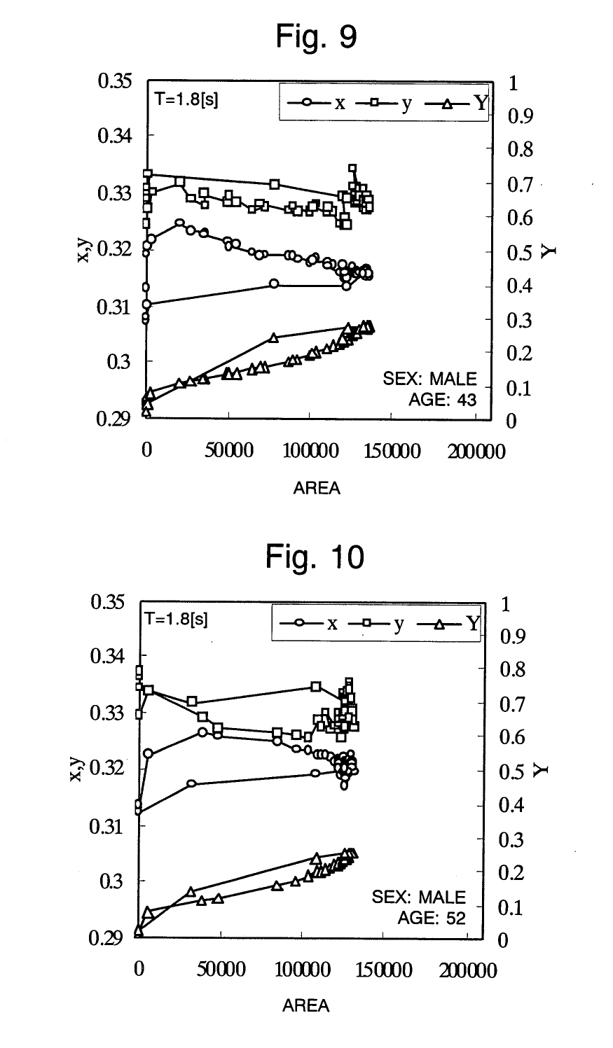

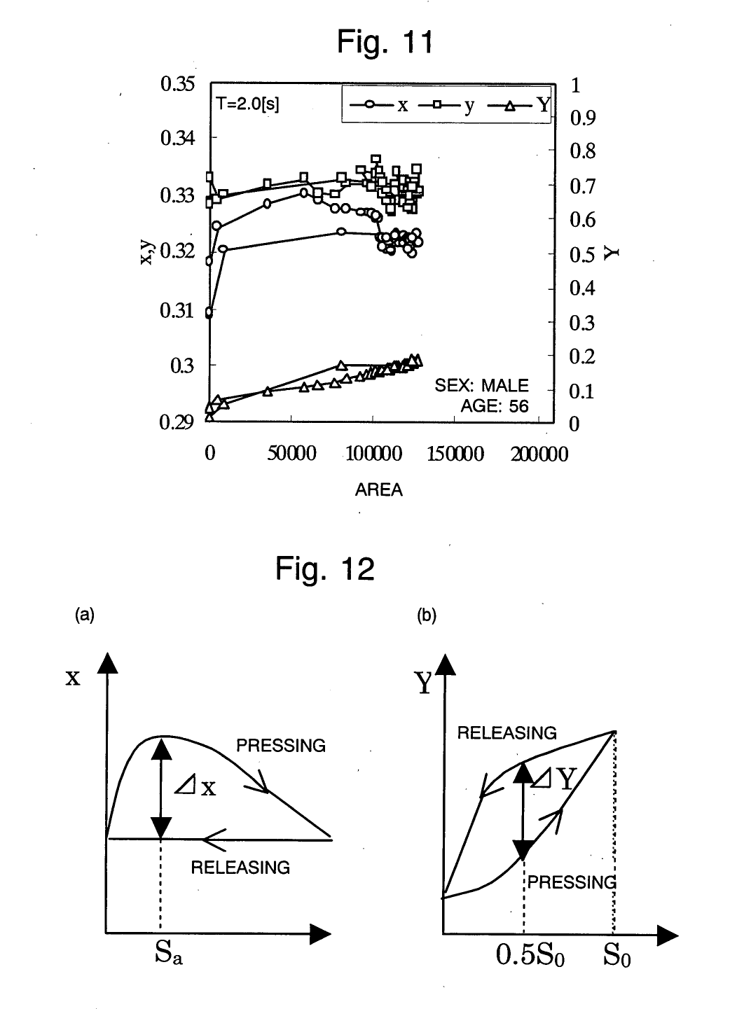

The experiment and analysis described thus far was further carried out on four subjects of different ages. FIGS. 8 to 11 show the chromaticity coordinate x, chromaticity coordinate y and tristimulus value Y plotted against the area at the pressure time T=1.8 seconds for three subjects and T=2.0 seconds for one subject. These results prove that the characteristics explained earlier are independent of the ages of the subjects.

The results of the experiments described thus far can be modeled as shown in FIG. 12. From these results, it is possible to create various criteria for liveliness detection, as follows: FIG. 12(a) shows a liveliness detection method in which the difference in the chromaticity coordinate x between the pressing and releasing phases at a certain value Sa of the contact area is defined as Δx, and the finger is regarded as a live finger if the value Δx exceeds a predetermined threshold. FIG. 12(b) shows another method in which, with the maximum value of the contact area denoted by S₀, the difference in the tristimulus value Y between the pressing and releasing phases at a point where the contact area is 50% of S₀ is defined as ΔY, and the finger is regarded as a live finger if the value ΔY exceeds a predetermined threshold. As can be understood from FIG. 12, it is possible to create various methods other than the above ones.

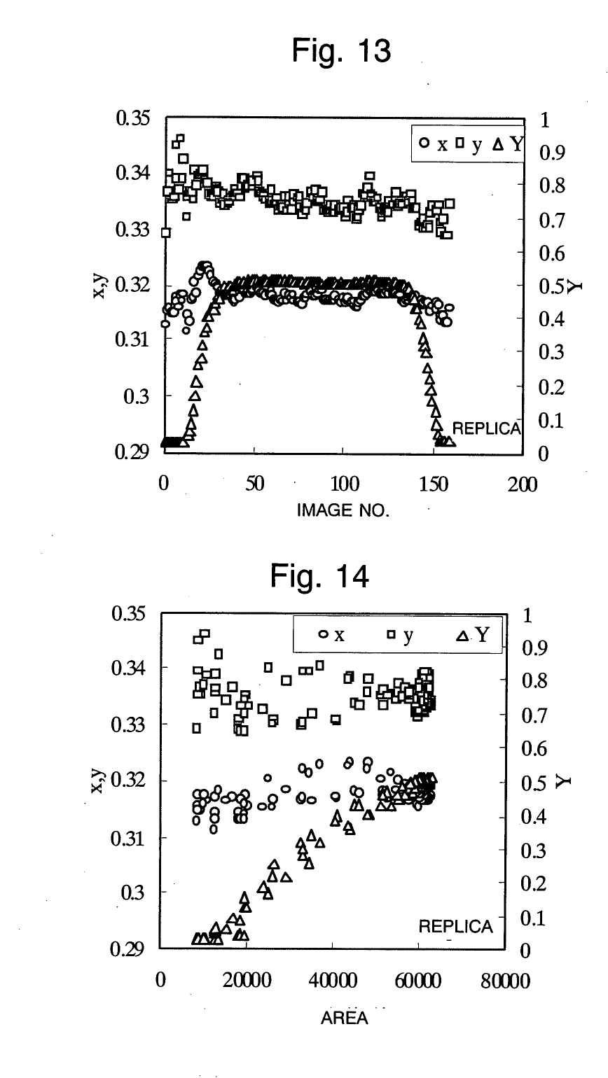

FIGS. 13 and 14 show the result of the same experiment using a faked finger made of a room-temperature vulcanization (RTV) resin. It should be particularly noted that the graph in FIG. 14, in which the coordinate x and the tristimulus value Y are plotted against the area, shows little or no hysteresis effect. This clearly differs from the corresponding graphs in FIGS. 5 to 11, in which a live finger was used. Thus, it has been confirmed that the method according to the present invention is effective for liveliness detection.

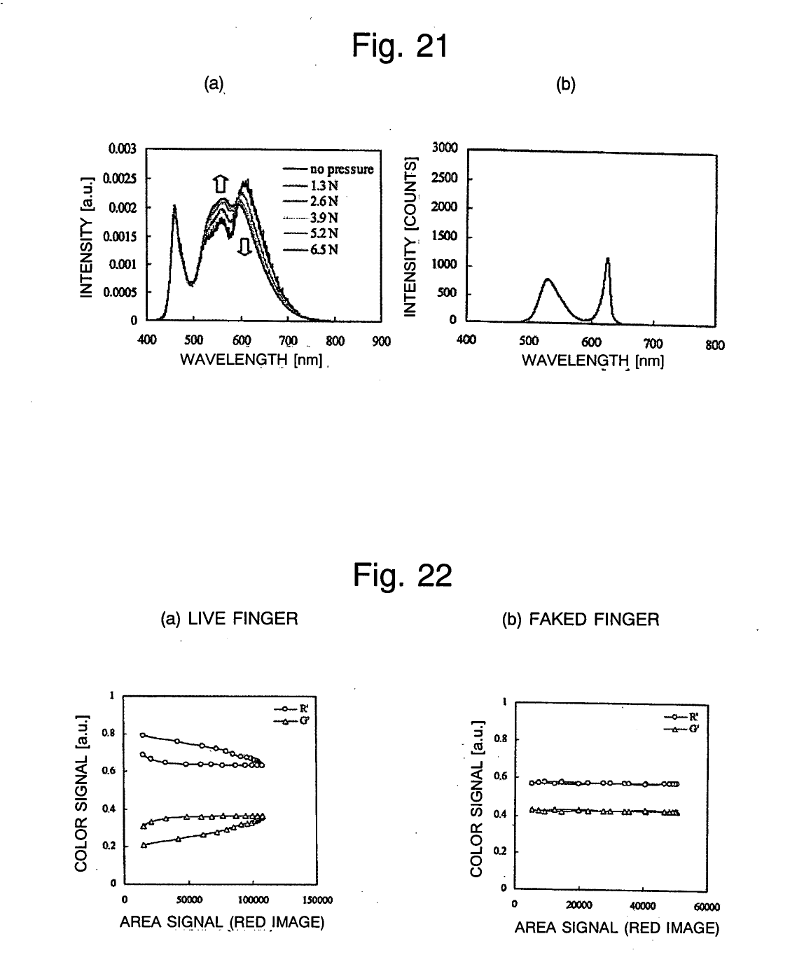

The effect of the color of the light source was also investigated. The light source 10 used in the measurements was a white light source commonly used in normal fingerprint sensors. FIG. 21(a) is a graph showing the spectrum of the scattered light obtained for several pressure values while a finger of a 22-year-old male subject was being pressed onto a fingerprint sensor using a white light source. The graph shows that the intensity change is particularly large at wavelengths of about 550 nm (green) and 630 nm (red). More specifically, the green component of the spectrum particularly intensifies with the increase of the pressure, while the red component particularly weakens.

The above result suggested that the detection of a live finger would be easier by using a “GR” light source containing only the aforementioned two wavelength components. Accordingly, using a GR light source consisting of a green light-emitting diode (G-LED) having a central wavelength of 535 nm and a red LED (R-RED) having a central wavelength of 630 nm, the same measurements as in the previous examples were carried out. FIG. 21(b) shows the spectrum of the GR light source hereby used.

The test fingers hereby used were those of males and females of 21 to 62 years old. The measurements also used eleven types of faked fingers made of silicone, urethan, gelatin and other materials. Each of these live and faked fingers was pressed onto and then released from a fingerprint sensor employing the aforementioned GR light source, and image signals were collected during those actions. FIGS. 22(a) and 22(b) show examples of the image signals. In these graphs, the abscissa is the area (the number of pixels) of the touching portion of the finger and the ordinate is the normalized value of the G-signal (G′-value) and the normalized value of the R-signal (R′-value), which are defined as follows:
G′=G/(G+R), R′=R/(G+R)

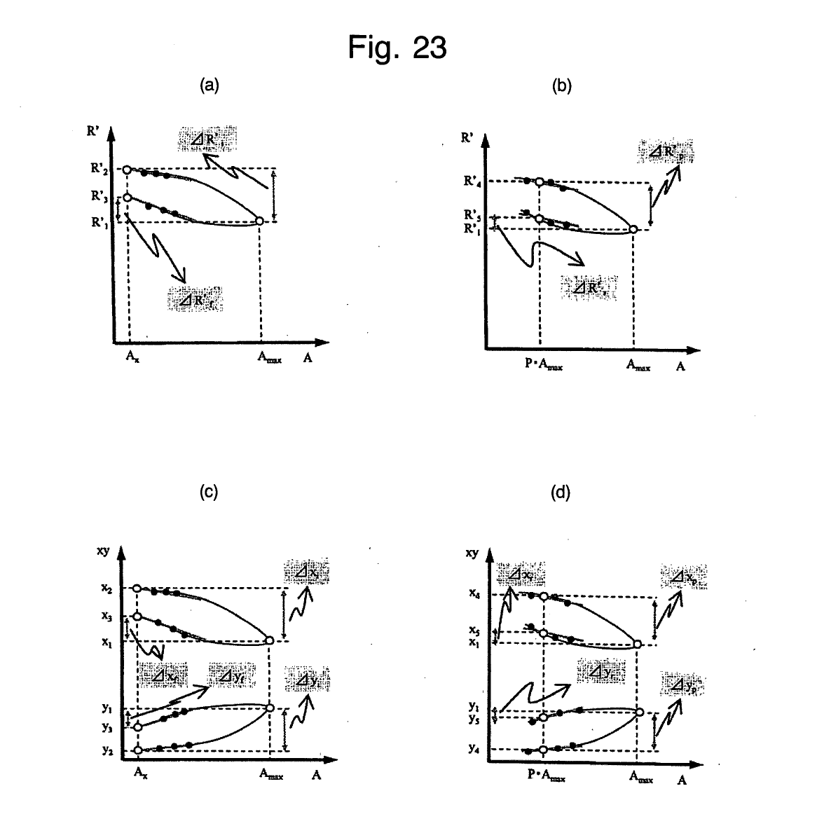

From these graphs, various indices were extracted and it was determined which of those indices most clearly reflected the distinction between the live fingers and the faked ones. The indices hereby created are as shown in FIGS. 23(a) to 23(d). In FIG. 23(a), ΔR′i is the change of the R′-value from an initial pressure point, where the contact area is at a predetermined initial value Ax, to a maximum pressure point, where the contact area reaches its maximum value Amax, during the pressing phase. The index ΔR′f is the change of the R′-value during the period of time for the contact area to return from the maximum value Amax to the initial value Ax in the pressure-releasing phase. The area surrounded by the pressing and releasing curves are denoted by SR′. In FIG. 23(b), ΔR′p is the change of the R′-value from the point where the contact area reaches a certain percentage p (0≦p≦1) of the maximum value Amax to the maximum value Amax during the pressing phase, and ΔR′r is the change of the R′-value between those two points during the releasing phase. In FIG. 23(c), Δx′i is the change of the chromaticity coordinate x from an initial pressure point, where the contact area is at a predetermined initial value Ax, to a maximum pressure point, where the contact area is at the maximum value Amax, during the pressing phase. The index Δxf is the change of the R′-value during the period of time for the contact area to return from the maximum value Amax to the initial value Ax in the pressure-releasing phase. The indices Δyi and Δyf indicate similar changes of the chromaticity coordinate y. In FIG. 23(d), the indices Δxp, Δxr, Δyp and Δyr for the chromaticity coordinates x and y are equivalent to the indices ΔR′p and ΔR′r for the R′-value in FIG. 23(b). In the experiments, the initial value Ax was set at 2000, 5000 and 10000 and the percentage p was set at 0.2, 0.5 and 0.8.

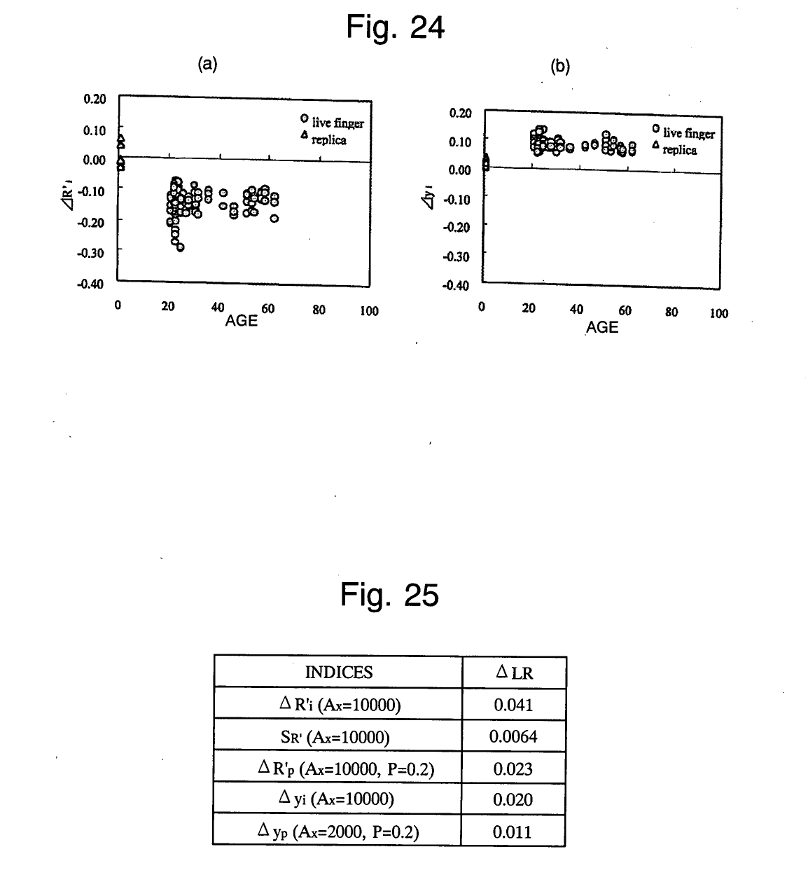

The pressure from each of the 42 pieces of live fingers and the 11 pieces of faked fingers during the pressing and releasing phases was measured with the fingerprint sensor and the change of each of the above indices was investigated. The results showed that the live finger group was clearly separated from the faked finger group; the values of the live fingers did not overlap with those of the faked fingers in any of the indices. FIG. 24(a) shows an example, where the values of the index ΔR′i of the faked finger group are within a range from −0.04 to +0.07, whereas those of the live finger group are within a range from −0.30 to −0.06. This result suggests that the live fingers can be definitely discriminated from the faked fingers by setting the threshold for ΔR′i within a range from −0.06 to −0.04. FIG. 24(b) shows another example, in which the values of the index Δyi of the faked finger group are within a range from −0.01 to +0.04, whereas those of the live finger group are within a range from +0.05 to +0.15. This result suggests that the live fingers can be definitely discriminated from the faked fingers by setting the threshold for Δyi within a range from +0.04 to +0.05.

Thus, the distance ΔLR between the faked fingers (“replicas”) and the live fingers (i.e. the difference between the maximum value of the live finger group and the minimum value of the faked finger group or the difference between the minimum value of the live finger group and the maximum value of the faked finger group) was the largest in ΔR′i, followed by ΔR′p and Δyi, as shown in FIG. 25. Therefore, it can be said that these indices are more reliable in discriminating live fingers from faked ones. It should be also noted that ΔLR is larger than zero also in the other indices (e.g. Δyp, SR′ and so on), which means that the values of the live finger group are not mixed with those of the faked finger group. Therefore, it is possible to clearly distinguish live fingers from faked ones by setting a threshold of any of the above indices between the two groups.

Another example of the liveliness detection method uses an index different from that of the previous example. Conventional color expression methods or color specification systems include the LHS, Lab, Luv and so on, in addition to the XYZ system. These systems can be converted from one to another by appropriate transformation equations. However, these equations are not always linear. Therefore, even if a certain index is useful to clearly discriminate live fingers from faked ones in a certain color specification system, that index cannot always be the most appropriate one in a different color specification system. The latter color specification system may have a different, more appropriate index for discriminating live fingers from faked ones.

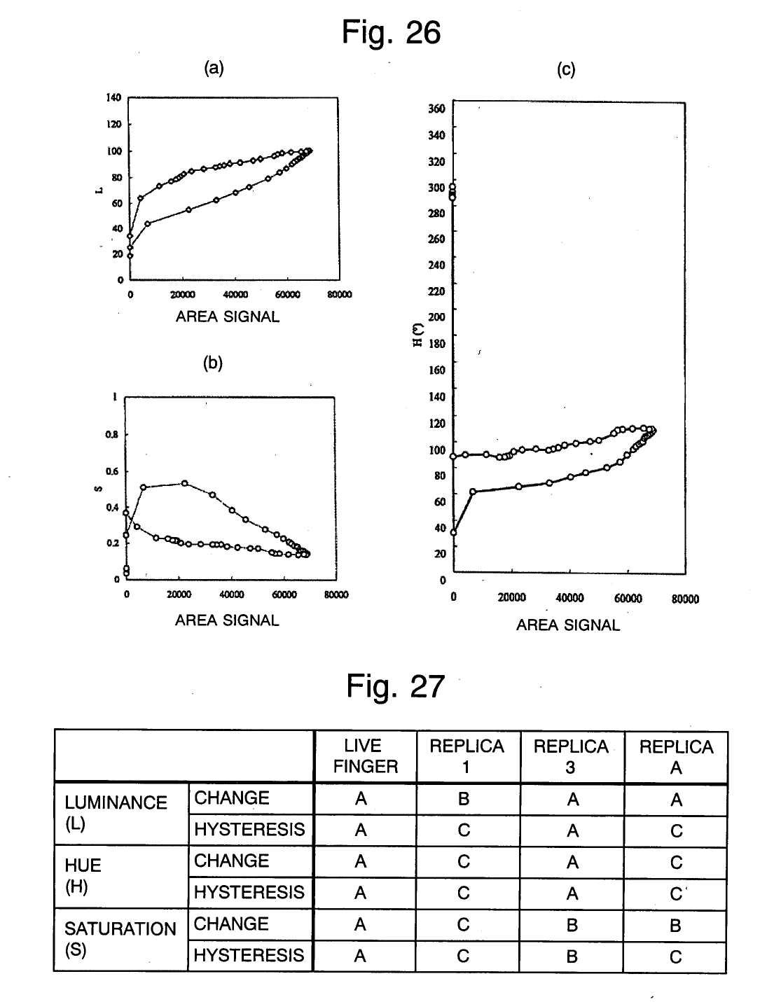

Accordingly, various measurements were made also on the LHS color specification system, which is also one of the popularly used systems in addition to the XYZ system. Test fingers hereby used were three live fingers and three faked fingers. FIGS. 26(a), 26(b) and 26(c) show the changes of the luminance (L), chroma saturation (S) and hue (H) of one of the tested live fingers, respectively. These figures clearly show that this live finger made significant changes in the indices L, S and H of the LHS system. This tendency was also found in the cases of the other live fingers. In contrast, the faked fingers exhibited different amounts of change, depending on their types. The table in FIG. 27 shows the results. In this table, the amount of the color change is evaluated by three levels: A (large change), B (medium change) and C (small change). As is clear from this table, in the LHS color specification system, the chroma saturation S is better capable of reflecting the difference between the live fingers and the faked ones.

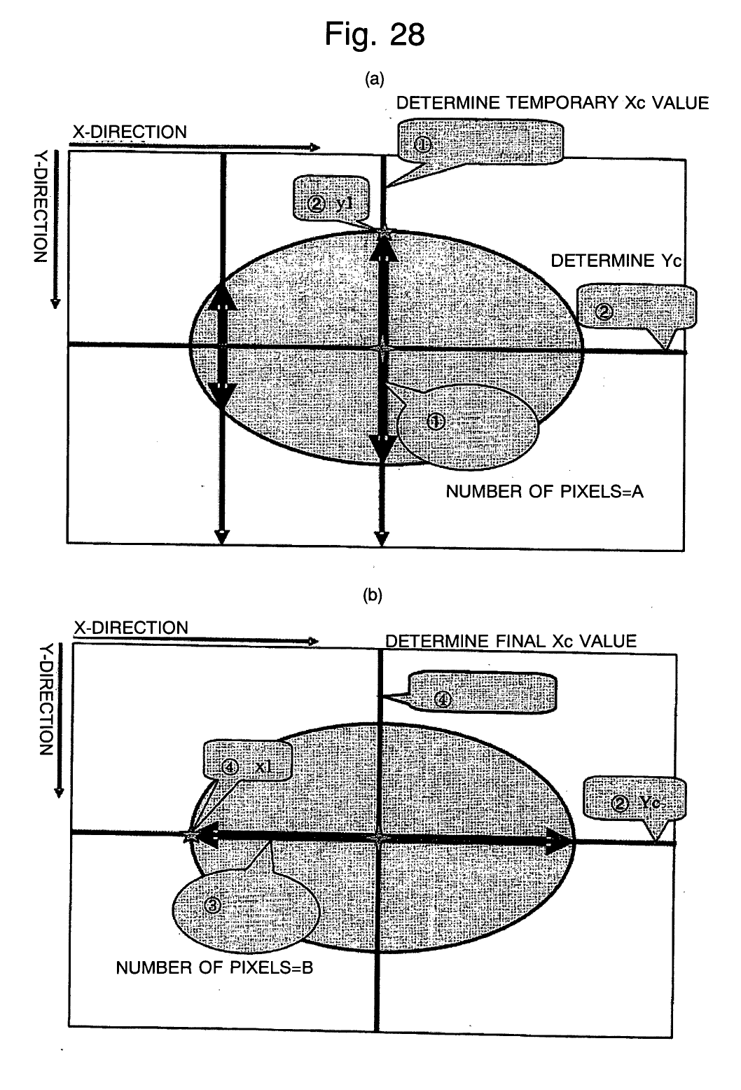

A technique for automatically detecting the center of the touching portion of the finger on the sensor surface is described. This technique is to extract the color signal in a stable manner, irrespective of how the finger is pressed onto the sensor. FIGS. 28(a) and 28(b) schematically show the method of determining the center of the touching portion of the finger (“automatic center determination method”). First, the pixels whose values are equal to or larger than a threshold of 50 are counted along the Y axis, and the X coordinate that gives the largest count is temporarily designated as Xc. The number of the pixels counted is designated as A. On the line X=Xc, the Y coordinate of the pixel at which the value exceeds the threshold of 50 for the first time is located as y1. Then, Yc is calculated by Yc=y1+A/2. On the line Y=Yc, the number of the pixels whose values are equal to or larger than the threshold of 50 is designated as B. Then, the X coordinate of the pixel at which the value exceeds the threshold for the first time on the line Y=Yc is located as x1, and the actual value of Xc is calculated by Xc=x1+B/2.

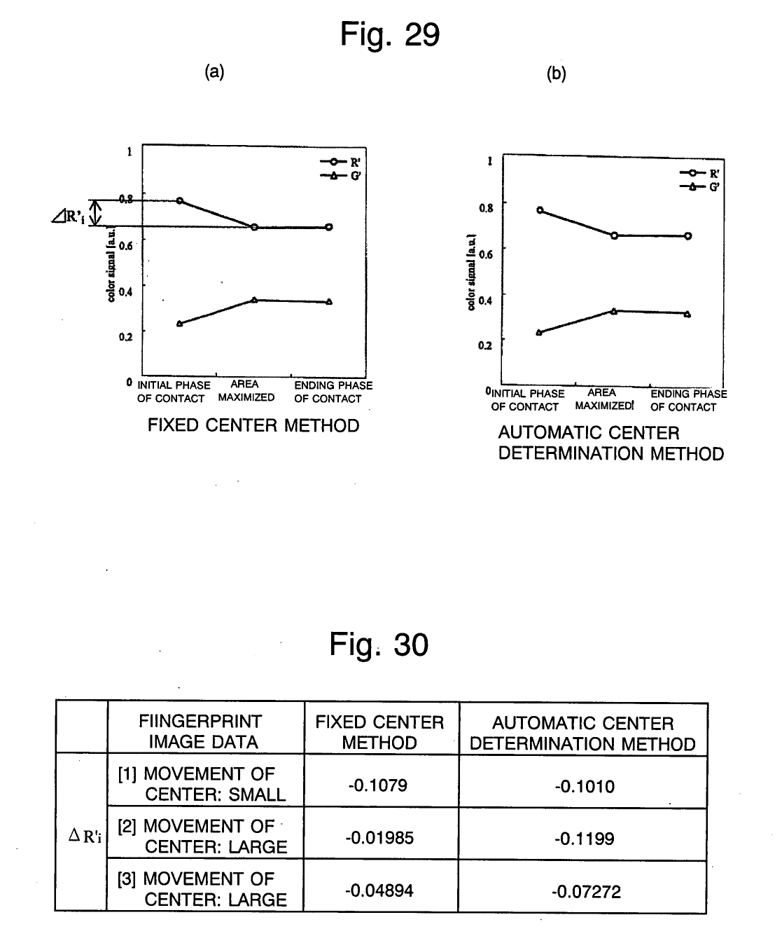

To check the effectiveness of this method, the same measurements as described earlier were carried out using the method. The aforementioned GR light source was used to measure the G-values and the R-values. After these values were normalized to G′-value and R′-values, the index ΔR′i explained earlier was calculated. FIG. 29(a) shows the result obtained using the fixed center method and FIG. 29(b) shows the result obtained using the automatic center determination method. FIG. 30 is a table comparing the ΔR′i values derived from the two results. A larger absolute value of ΔR′i means a higher level of effectiveness for liveliness detection. It has been confirmed that the automatic center determination method yields better results when the movement of the center of the touching portion of the finger is large.

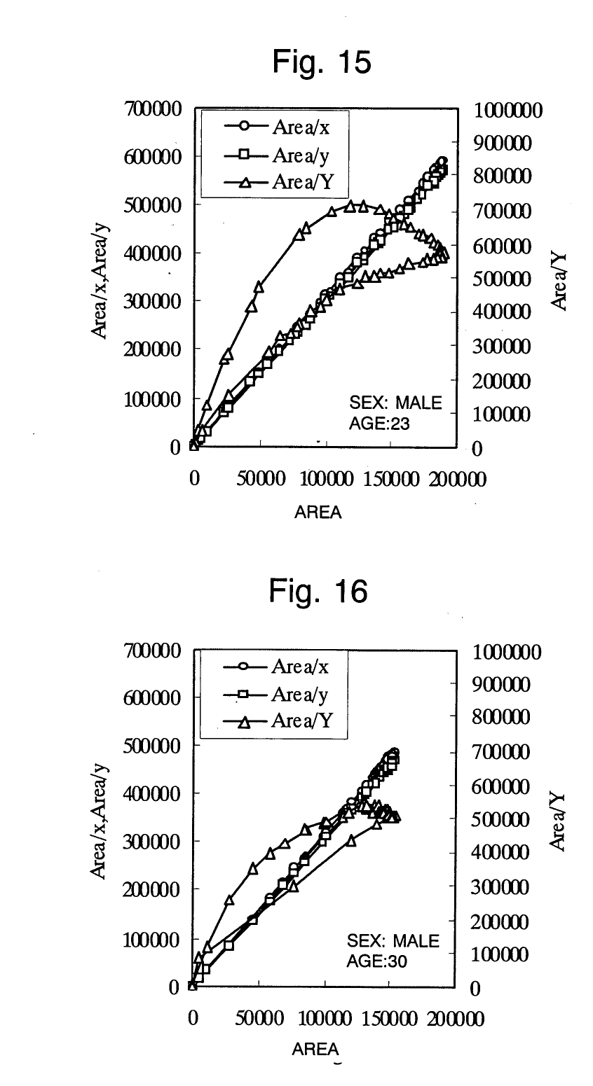

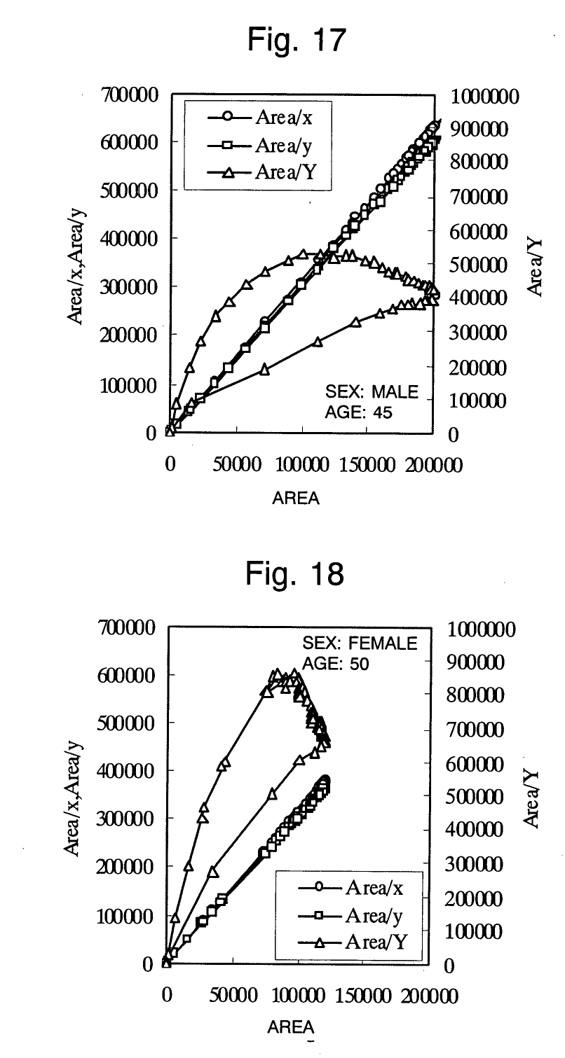

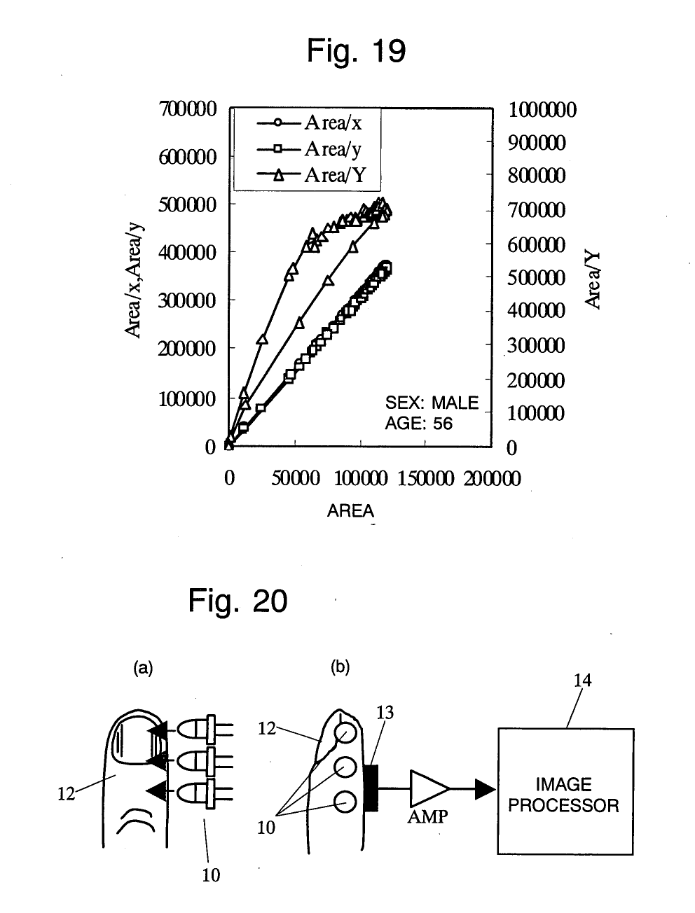

An example of the fitness measurement method according to the present invention is described. Five male and female subjects of 23 to 56 years old were requested to press their fingers on the inspection surface (the light-guiding plate 11) of the fingerprint sensor of the same system as used in the previous example shown in FIG. 1. In the meantime, the image data produced by the image sensor 13 at a rate of 30 frames per second were collected, and the sRGB value of the central portion of each image was converted to the chromaticity coordinates x, y and the tristimulus value Y, similar to the previous case. The data thereby collected were plotted on a graph, with the abscissa indicating the contact area and the ordinate indicating [Area S]/[Chromaticity coordinate x], [Area S]/[Chromaticity coordinate y] and [Area S]/[Tristimulus value Y]. FIGS. 15 to 19 show the results. The indices [Area S]/[Chromaticity coordinate x] and [Area S]/[Chromaticity coordinate y] derived from the chromaticity coordinates x and y have no meaningful correlation with the age. In contrast, the index [Area S]/[Tristimulus value Y] derived from the tristimulus value Y has a tendency to increase with age.

As explained earlier, this index can be regarded as an indicator of the stiffness of the blood vessel of the finger. Therefore, FIGS. 15 to 19 demonstrate that the stiffness of the blood vessel increases with age. This tendency undoubtedly matches the generally understood physiological tendency. Thus, it can be said that the index according to the present invention can be used as a fitness index.

1. A method for extracting liveliness information from a fingertip, which is characterized in that the liveliness information is extracted from a relationship between following two properties of a finger being pressed onto an inspection surface: the color of the finger at its touching portion, and either a contact area of the finger or a quantity reflecting the contact area.

2. A liveliness detection method using information extracted from a fingertip, which is characterized in that it determines whether or not the finger is a live finger, on a basis of a change in a color index of the finger at its touching portion during one or both of following two phases: a pressing phase, in which the finger is being pressed onto an inspection surface, and a releasing phase, in which the finger is being released from the inspection surface.

3. The liveliness detection method according to claim 2, which is characterized in that the aforementioned color index is one of following values: chromaticity coordinate x, chromaticity coordinate y and tristimulus value Y of the CIE color specification system.

4. The liveliness detection method according to claim 2, which is characterized in that the aforementioned color index is one of following values: the luminance L, hue H and chroma saturation S of an LHS system.

5. The liveliness detection method according to claim 1, which is characterized in that it uses a light source emitting light within wavelength ranges of green light and red light.

6. The liveliness detection method according to claim 1, which is characterized in that a center of the touching portion is automatically determined by an automatic center determination method.

7. A liveliness detection system using information extracted from a fingertip, which is characterized in that it comprises:
a) an inspection surface onto which a finger is to be pressed;
b) a color detector for measuring a color of the finger at a portion touching the inspection surface;
c) a color monitor for checking a color index of the finger at its touching portion during one or both of following phases: a pressing phase, in which the finger is being pressed onto the inspection surface, and a releasing phase, in which the finger is being released from the inspection surface; and
d) a liveliness detector for determining whether or not the finger is a live finger, on a basis of a change of the color during each of the aforementioned one or both phases.

8. The liveliness detection system according to claim 7, which is characterized in that it uses a light source emitting light within wavelength ranges of green light and red light.

9. A fitness measurement method using information extracted from a fingertip, which is characterized in that an index indicative of a stiffness of a blood vessel of a finger being pressed onto an inspection surface is derived from a change in a color index of the finger at its touching portion, where the color index corresponds to a change in a contact area of the finger or a quantity reflecting the contact area.

10. The fitness measurement method according to claim 9, which is characterized in that the aforementioned color index is one of following values: chromaticity coordinate x, chromaticity coordinate y and tristimulus value Y of the CIE color specification system.

11. The fitness measurement method according to claim 9, which is characterized in that the aforementioned color index is one of following values: the luminance L, hue H and chroma saturation S of an LHS system.

12. The fitness measurement method according to claim 9, which is characterized in that a light source emitting light within wavelength ranges of green light and red light is used.

13. The fitness measurement method according to claim 9, which is characterized in that a center of the touching portion is automatically determined by an automatic center determination method.

14. A fitness measurement system using information extracted from a fingertip, which is characterized in that it comprises:
a) an inspection surface onto which a finger is to be pressed;
b) an area-measuring means for measuring either a contact area of the finger on the inspection surface or a quantity reflecting the contact area;
c) a color detector for measuring a color of the finger at a portion touching the inspection surface; and
d) a stiffness calculator for computing an index indicative of a stiffness of a blood vessel of the finger from a change in an index of the aforementioned color corresponding to a change of the contact area.

15. The fitness measurement system according to claim 14, which is characterized in that it uses a light source emitting light within wavelength ranges of green light and red light.
